(19) United States
(12) Patent Application Publication
(10) Pub. No.: US 2013/0191474 A1
(43) Pub. Date: Jul. 25, 2013

(54) Electronic Messaging Recovery Engine

(71) Applicants: Manish Kumar Goel, Singapore (SG); Roland John Turner, Singapore (SG)

(72) Inventors: Manish Kumar Goel, Singapore (SG); Roland John Turner, Singapore (SG)

(73) Assignee: BoxSentry Pte Ltd, Singapore (SG)

(21) Appl. No.: 13/702,575

(22) PCT Filed: Jun. 7, 2011
(86) PCT No.: PCT/AU2011/000706

§ 371 Date: Mar. 28, 2013

(30) Foreign Application Priority Data
Jun. 7, 2010 (SG) 201003981-6

(51) Int. Cl. H04L 12/58

(52) U.S. Cl. CPC H04L 51/12
USPC 709/206

(57) ABSTRACT

The disclosure relates to ensuring wanted electronic messages are reliably delivered to recipients by distinguishing between wanted, authenticated messages and other messages. Notifications of messages that have been identified as spam are received (60) by a messaging recovery engine (30). The engine (30) via recovery module (44) determines (62) whether the email is in fact spam and if it is not spam generates (64) a notification to this effect, such as storing details in a database (34) or by generating instructions (48) to have the message delivered. The advantage is that after-the-fact analysis of security screened electronic messages can be performed. This makes it possible to use the method disclosed with existing messaging security systems with little or no modification to those existing systems. This in turn minimises barriers that would otherwise prevent adoption of methods for reducing false identification of a wanted message as an unwanted message allowing the messaging systems to benefit from improved message delivery.

### CROSS REFERENCE

Incorporated herein by reference is PCT/AU2006/001571 entitled “Electronic message authentication”, published as WO2007/045049. Also incorporated herein by reference is PCT/AU2009/0066011 entitled “Electronic messaging integrity engine”, published as WO2010/066011.

### TECHNICAL FIELD

This disclosure concerns electronic messaging/communications, such as, but not limited to, email messages. It includes but is not limited to helping to ensure wanted electronic messages are reliably delivered to recipients by reducing the number of electronic messages that are identified as unwanted incorrectly. Aspects include methods, software and computer systems for reducing incorrect identification of wanted inbound electronic messages as unwanted electronic messages.

### BACKGROUND ART

Electronic messaging, such as email, SMS and VoIP, is a ubiquitous and low cost form of communication between people across publically accessible computer/communications networks, such as the internet. The accessibility and use of electronic messaging is continually increasing in both business and private communities. Further, the senders of electronic messages generally expect their messages to be delivered and to be of value to the recipient.

Generally, electronic messages are sent by humans using computers or by software that has been designed to compile and transmit the same message to one recipient or to many recipients substantially simultaneously on a public communications network. Electronic messaging software can be used not only to transmit, for instance, wanted/solicited newsletters to interest groups, but also to transmit unwanted (such as illegitimate or unsolicited) emails on mass commonly referred to as ‘spam’. A consequence is that many users find their email box filling with wanted emails from both known and unknown senders, and in addition nuisance unwanted emails typically from unknown senders.

As the volume of unwanted emails grows, more time and resource is consumed in identifying, preventing and/or deleting them. Some organisations attempt to exclude unwanted emails by applying blocking or filtering criteria against the incoming email stream. However, mass emailing operators have responded by disguising their nuisance emails to look like wanted messages thus rendering many of these filtering methods less effective and more likely to cause ‘false positives’ (wanted messages misidentified as unwanted/unsolicited messages).

In general, apart from requiring continual improvement, filtering methods suffer from the disadvantage that wanted emails can be accidentally blocked by inadvertently meeting the filtering criteria. For example, an email between business contacts that includes a word which may be considered to be used in many spam emails (such as ‘mortgage’) thus inadvertently has a score that exceeds the threshold. This results in the false identification of a wanted email as an unwanted email, referred to as a ‘false positive’.

If the combined filtering method of an anti-spam system blocks a percentage of emails incorrectly, over time this accumulates to a large number of valuable wanted emails that are not received by the addressed recipient. This in turn results in potential harm for an organisation due to the loss in wanted communications. This impacts the integrity of the business processes which rely on email to facilitate communication or interaction between the senders and recipients.

Any discussion of documents, acts, materials, devices, articles or the like which has been included in the present specification is solely for the purpose of providing a context for the present disclosure. It is not to be taken as an admission that any or all of these matters form part of the prior art base or were common general knowledge in the technical-field as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

In a first aspect there is provided a computer-implemented method for reducing incorrect identification of wanted inbound electronic messages as unwanted electronic messages, the method comprising the steps of:
(a) receiving a notification of an inbound electronic message that has been identified as unwanted and not delivered to the addressed recipient of the electronic message, the notification including identification information of the electronic message;
(b) based on the identification information, determining whether the identification of the inbound electronic message as unwanted is substantially incorrect; and
(c) if identification of the electronic email as unwanted is determined as substantially incorrect, generating a notification that the electronic message is wanted.

Organisations seeking to avail themselves to the benefits of reducing incorrect identification of wanted inbound electronic messages as unwanted messages (false-positive) encounter cost barriers and typically organisation resistance barriers to adoption because of the need to alter complex existing messaging systems in order to do so. Additionally, the invisibility of message loss through false-positive errors makes it difficult for a case to be made for taking action to avoid or to correct false-positive errors at all.

It is an advantage of this method that after-the-fact analysis of security screened electronic messages can be performed. This makes it possible to use the method with existing messaging security systems with little or no modification to those existing systems. This in turn minimises barriers that would otherwise prevent adoption of methods for reducing false-positive errors allowing the messaging systems to benefit from improved message delivery.

The use of after-the-fact detection of false-positive errors and notification also serves to raise the visibility of the problem of message loss.

It is yet a further advantage that the use of after-the-fact detection of false-positive errors and notification also serves to assist in service level agreement (SLA) compliance monitoring of the existing messaging security system.

Step (a) may further include receiving notifications of a plurality of inbound and identified as wanted electronic messages and outbound electronic messages, the notifications including identification information of the electronic messages, and step (b) is also based on the identification information of the plurality of inbound and identified as wanted electronic messages and outbound electronic messages.

Inbound and outbound refer to the direction of emails from the perspective of a particular network, typically as viewed from the end user's perspective of that network, the end user being the recipient of an inbound message and the sender of an outbound message.

The notification may be provided by a messaging security system, such as an anti-spam email system. The notification maybe received by downloading from a datastore the notification such as log data or data, such as the emails themselves, from which the notifications can be determined.

The identification information of the inbound electronic email may include an electronic message address of the sender of the inbound message and an IP address of the sender of the inbound message. The identification information may further include the electronic message address of the recipient of the inbound message and the subject line of the electronic message.

Step (b) may comprise performing the method of reducing incorrect identification of wanted inbound electronic messages received from a communications network as unwanted electronic messages described in PCT application No. PCT/AU2009/001614 (published as WO 2010/066011).

Step (b) may comprise sending a query containing the identification information to a messaging security system and receiving in reply an indication of whether the identification of the inbound electronic message as unwanted is substantially incorrect.

The method used for determining in step (b) may be dynamically selected based on the types of identification information received for the electronic message or where the notification is received from. For example, where no identification information of outbound emails is available, analysis based on global white list style or based on the IP address of the sender may be performed. Otherwise, if information based on outbound emails is available or the notification is received from a messaging security system having a preferred method nominated, the method described in No. PCT/AU2009/001614 can be more accurately used.

Step (b) determines where identification of the inbound electronic message as unwanted is substantially incorrect, that is incorrect at least according to its own analysis.

The notification of step (c) may cause the electronic message to be delivered to the addressed recipient. Generating the notification of step (c) may comprise sending instructions to a messaging system to cause the electronic message to be delivered. It is an advantage of this embodiment that the method can be used to automatically have the message that has been incorrectly identified as unwanted correctly delivered.

The method may further comprise staring the notification that the electronic message is wanted. It is an advantage of at least this embodiment that reports and other statistics can be generated over time for incorrect identification of wanted electronic messages as unwanted electronic messages.

The method may further comprise repeating the method so as to generate notifications that further electronic messages identified as unwanted are wanted, and the notifications of step (a) are received from multiple sources and/or in different formats, and the method further comprises the step of processing the received notifications to be in a suitable predetermined single format for use in step (b).

In a second aspect there is provided a computer system for reducing incorrect identification of wanted inbound electronic messages as unwanted electronic messages, comprising:
an input port to receive a notification of an inbound electronic message that has not been delivered to the addressed recipient of the electronic message, the notification including identification information of the electronic message; and
a processor (e.g. recovery module) to determine, based on the identification information, whether the identification of the inbound electronic message as unwanted is substantially incorrect and if the electronic email identified as unwanted is determined as being substantially incorrect, generating a notification that the electronic message is wanted.

The computer system may include an output port to send the notification that the electronic message is wanted, such as to a third party messaging system.

The computer system may include a datastore to store the notification that the electronic message is wanted.

In a third aspect there is provided software, that is computer readable instructions stored on computer readable memory, that when installed and executed by a computer system causes the computer to perform the method described directly above.

Optional features of the first aspect are also optional features of the second and third aspects described here.

In a fourth aspect there is provided a computer-implemented method for reducing incorrect identification of wanted inbound electronic messages as unwanted electronic messages, the method comprising:
(a) determining that an inbound electronic message is unwanted to prevent the electronic message from being delivered to the addressed recipient of the electronic message;
(b) providing or making available a notification that the inbound electronic message has been identified as unwanted to a third party electronic messaging security system (e.g messaging recovery engine), the notification including identification information of the electronic message; and
(c) receiving instructions from the third party electronic messaging security system to cause the electronic message to be delivered to the addressed recipient.

Providing the notification in step (b) may be made by making the identification information available for download or by sending the information to the third party electronic messaging system.

In a fifth aspect there is provided a computer system for reducing incorrect identification of wanted inbound electronic messages as unwanted electronic messages, comprising:
a processor to determine that an inbound electronic message is unwanted preventing the electronic message from being delivered to the addressed recipient of the electronic message, and to cause the electronic message to be delivered to the addressed recipient on instruction from a third party electronic messaging security system;
a communications port to provide or make available a notification that the inbound electronic message has been identified as unwanted to the third party email security system and to receive instructions from the third party email security system to cause the electronic message to be delivered to the addressed recipient.

In a sixth aspect there is provided software, that is computer readable instructions stored on computer readable memory, that when installed and executed by a computer system causes the computer to perform the method described directly above.

Optional features of the first and fourth aspect are also optional features of the fifth and sixth aspects described here.

The electronic message may be any one or more of text, graphic or sound based electronic message.

### BRIEF DESCRIPTION OF THE DRAWINGS

A non-limiting example will now be described with reference to the accompanying drawings:

FIG. 1 is a schematic diagram of the computer system having the messaging recovery engine.

FIG. 2 is a schematic diagram of the components of the messaging recovery engine.

FIG. 3 is flow chart showing the method for reducing incorrect identification of wanted inbound electronic messages as unwanted electronic messages.

### BEST MODES

An example will now be described with reference to the accompanying drawings. In this example the electronic messages are emails.

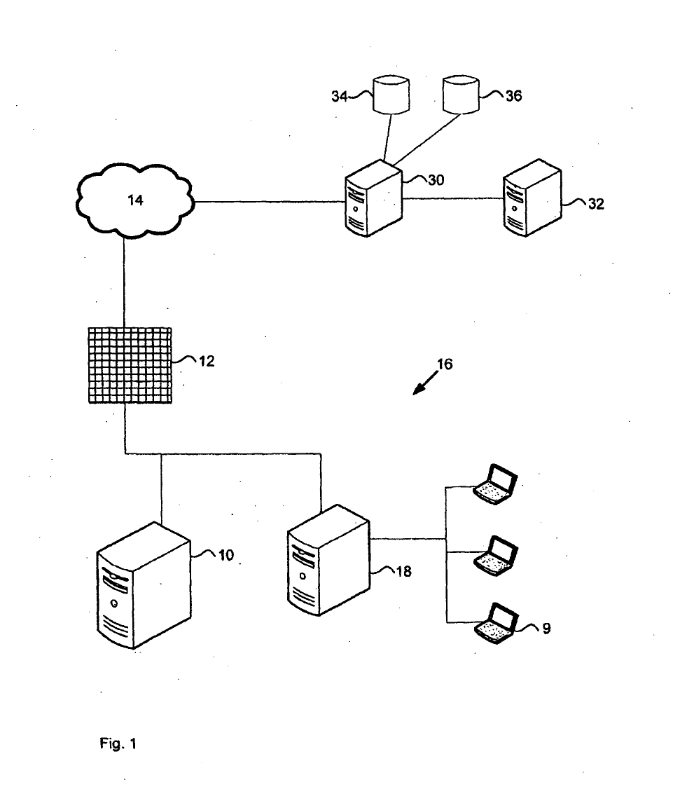

Referring first to FIG. 1, a single typical installation of this example is shown. An existing messaging system is provided on a private network 16 and includes a message security system, such as an anti spam server 10, and an email server 18 situated behind a firewall 12 protecting them from the internet 14. The email server 18 operates as the email server for multiple local domains on the local network 16. The anti-spam server 10 and the email server 18 form a pre-existing mail security system.

The anti-spam server 10 of this example receives all inbound emails and using a local processor analyses each email to determine whether the email is wanted, that is whether it is spam. In this example, if an message is identified as spam the email is stored in quarantine and is prevented from being delivered to the addressed recipient, such as simply not providing the electronic message to the email server 18 for delivery to the recipient on the local network 16, such as making the email accessible by a user using an email client installed on a personal computer (one shown at 9). Typically to assist with the identification of spam emails, the anti-spam server 10 also receives information on all outbound emails to be sent from the email server 18 to outside the local network 16.

The example here is a messaging security system referred to as messaging recovery engine 30 and is retrofitted to the pre-existing email security system described above to reduce the incorrect identification of wanted inbound electronic emails as unwanted. The messaging recovery engine 30 is in communication with the anti-spam server 10 via the internet 14. The message recovery engine 30 is in communication with an electronic messaging integrity engine 32. This messaging recovery engine 30 and integrity engine 32 are distinct to and remote from the anti-spam server 10 and are considered third party systems to each other.

The design and functionality of the integrity engine 32 is described in PCT publication WO2010/066011, the description of which is incorporated here by reference.

Messaging recovery engine 30 includes two datastores that are used during its operations—a configuration data store 36 and a reporting datastore 34. In this example, the integrity engine 32 and datastores 34 and 36 resides on the same local network as the message recovery engine 30.

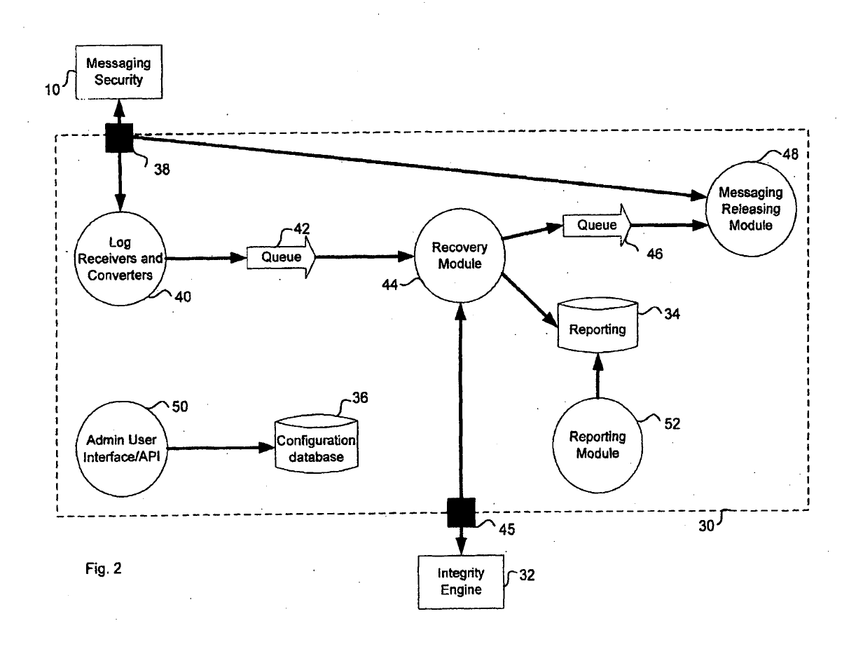

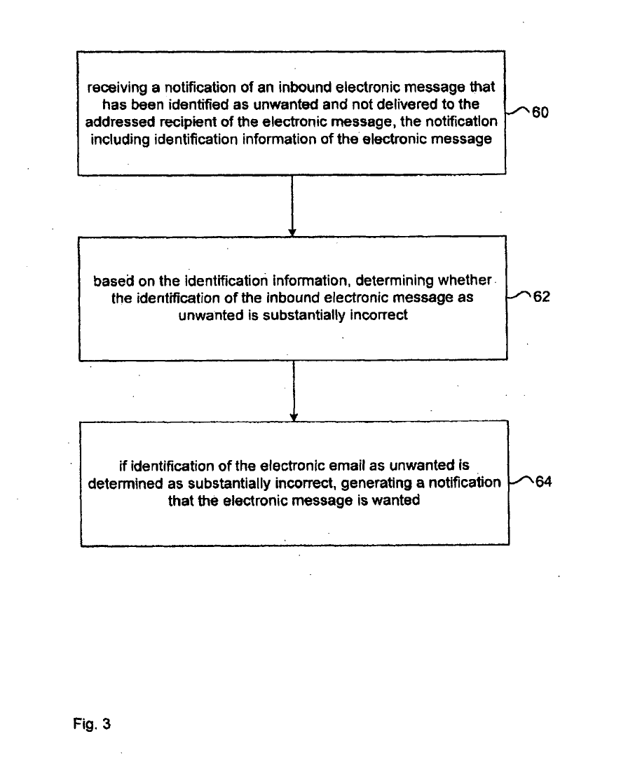

The features of the messaging recovery engine 30 are shown in more detail in FIG. 2 which will be described with reference to, the flow chart of FIG. 3.

In this installation example, the anti-spam server 10 provides from a communications port (not shown) to the messaging recovery engine 30 a set of notifications about inbound and outbound mails, each notification having identification information of each email such as an a unique identifier, an email address of the sender, an IP address of the sender, an email address of the recipient and the text of the subject line. In turn the messaging recovery engine 30 receives at the input port 38 the notifications and provides them to a log receiver 40. As a result a log of inbound and outbound messages of the private network 16 from the messaging security system 10 is received via the internet 14.

The message recovery engine includes a processor having functions of the log receiver and converter 40, recovery module 44, messaging releasing module 48 and reporting module 52.

The log converter 40 parses the received log data and converts them into a single internal pre-determined format used by the remaining components of messaging recovery engine 30. The resulting parsed and converted log data is then queued 42 for the recovery module 44. The recovery module 44 determines whether the email is in fact wanted. The recovery module generates 62 from the parsed and converted log data a query for each email (both inbound and outbound, both wanted or unwanted) that includes some or all of the received identification information and sends the query to the integrity engine 32 via the communications input/output port 45. Again via the communications port 45 the recovery module 44 receives in return an indication whether the email is in fact wanted or not. In this example, the indication includes an identifier of the query (and inturn associated email) and a flag that is set for either “wanted” or “unwanted”.

Where the query relates to an inbound email and was identified as unwanted by the anti-spam server 10, and the flag returned by the integrity engine 32 is that the email is wanted, a notification is generated by the recovery module 44. In this example, the generated notification is recorded in the datastore 34 and also queued 46 onto the releasing module 48. The releasing module 44 in turn converts each received notification into a message release instruction that is sent 64 to the anti-spam server 10 using the communications port 38. The message release instructions causes the processor of the anti-spam server 10 to change the classification of the email to wanted and have the email server deliver the email to the addressed recipient, such as releasing the email from the anti-spam server's 10 quarantine.

The recovery engine 30 also provides an admin user interface/API 50 and associated configuration datastore 36 to receive and maintain configuration information for the messaging recovery engine 30. The user interface 50 of this example is used to create, retrieve, update and delete user accounts that have the following information:
users—username, password, openID, roles/groups
instances of the integrity engine 32 associated with the account—hostname, which roles/groups have access, key
messaging security systems 10—name, which roles/groups have access, type, which integrity instance to use, log retrieval schedule, log-receiving parameters, reporting schedule, report retention time, whether to release detected false positives automatically

Periodically, the reporting module 52, generates a reports for corrections specific to the emails handled by the messaging system 10 and is able to automatically send the reports to the relevant administrator.

Further details of step 60 of FIG. 3 will now be described.

In the simplest case, all of the notifications, in this case logs, which the messaging recovery engine 30 uses to perform its function are provided by a dedicated messaging security system 10 as described with reference to FIG. 2. In more complicated cases, logs may also be provided from a dedicated message store (e.g. a mail-server which does not have anti-spam capabilities built in) or provided from a combined messaging security and store (e.g. a mail-server which has anti-spam capabilities built in). Either or both logs may also be provided from a log analysis and consolidation system that gets its logs from the messaging components by existing means. It is also possible for inbound log information to not come from logs at all but rather to infer this information through the use of existing APIs for accessing the contents of a quarantine; when a message appears in a quarantine that wasn't present earlier, the messaging recovery engine 30 can act as though a corresponding log entry for an inbound message had been received.

An example of a more complicated case is that of a dedicated messaging security system used only for inbound message handling connected to a dedicated message store which performs its own outbound delivery directly. In this case, the logs of inbound messages would need to come from the existing messaging security system—in order to include information about messages received but classified as spam and therefore not delivered—while the logs of outbound messages would need to come from the message store. For simplicity's sake, and without loss of generality, the rest of this document refers to all logs as though they are provided from a messaging security system, regardless of the actual source of the logs and arrangement of components.

There are several paths that logs may take to be provided or make available from the messaging security system to the messaging recovery engine:
The message recovery engine can periodically download logs directly from the messaging security system.
The messaging security system can periodically upload logs to message recovery engine.
The messaging security system can periodically upload logs to a storage facility to which both the messaging security system and message recovery engine have access. The messaging recovery engine can then periodically download the logs from the storage facility.
The messaging security system can send log entries to message recovery engine in real time via an appropriate protocol (e.g. the syslog protocol as described in IETF RFC 3164).

In the situations where the messaging recovery engine is downloading logs—either directly or via a storage facility—it can do so on a configured schedule, or in response to an API call from an external piece of software to trigger immediate commencement of a download, or both.

Protocols appropriate for uploading and downloading of logs include, but are not limited to, POST operations via HTTP, FTP, SMB, etc.

In some cases it may be preferable to dispense with log transfer entirely and instead to have the existing messaging security system deliver a copy of the inbound-classified-as-spam and/or outbound mail streams to the messaging recovery engine via SMTP. In this case, the existing messaging recovery engine would parse out internal format logs for queuing on the integrity engine client as other log receivers and converters do, but also to maintain a circular buffer of several minutes' inbound-classified-as-spam email as an internal “quarantine” from which detected false positives can be released on notification from the messaging realising module.

The means of receiving logs varies enormously between messaging security systems. An example of the means of extracting logs from Postini® is described which involves interacting with Postini®'s administrator website interface.

An HTTP POST request is sent to https://login.postini.com/exec/login with the following parameters:

| | |
|---|---|
| email | (administrator's email address) |
| pword | (administrator's password) |
| action | login |

The result is parsed for an <a> tag containing an href which contains /exec/adminstart and a GET request sent to the resulting URL.

The result is parsed for an <a> tag containing an href which contains /exec/logsearch and a GET request sent to the resulting URL.

The result is parsed for an <input> tag containing name=authtoken attribute and the associated value attribute is recorded for later use.

An HTTP POST is then sent to https://clients4.google.com/postini-logsearch-usa2/export with the following parameters:

| | |
|---|---|
| messageIds | (empty string) |
| type | all |
| previousQuery | (empty string) |
| authtoken | (the value recorded above) |
| startDate | (the desired inclusive starting moment in |
| | YYYYMMDDTHHMMSS format) |
| endDate | (the desired exclusive ending moment in |
| | YYYYMMDDTHHMMSS format) |
| timezone | (the timezone that the starting and ending |
| | moments are expressed in) |

The resulting CSV file is parsed to extract the per-message information required for calls to the integrity engine for false-positive error detection:

| | | Integrity engine/ |
|---|---|---|
| | Postini log CSV | check_sender |
| Item | field name: values | parameter name: values |
| direction | Direction: Inbound, | d: inbound, outbound |
| | Outbound | |
| spam verdict | Disposition: | v: spam if Quarantined, |
| | Quarantined, etc. | unknown otherwise |
| source IPv4 address, | Sender MTA | i |
| dotted quad notation | | |
| sender's email | From | s |
| address | | |
| recipient's email | To | r |
| address | | |
| message subject | Subject | subject |

Each parsed line is turned into a single/check_sender call to the integrity engine.

Further details of step 64 of FIG. 3 will now be described.

Typically the generated notification will include the identity information of the email and an indication that the message is wanted.

In most situations an interface present on the existing messaging security system will be used to release (typically a copy of) the quarantined message to the mail-server (examples include a quarantine management API, IMAP access to the quarantine or a “screen-scraping” tool which releases a message from the quarantine in a way which looks to the existing system like a user logging in and then selecting and releasing the message).

In some cases the user will elect not to have corrections performed automatically—or the messaging recovery engine will not have the means to use available interfaces—but prefer to review the list of apparent false-positives and release them manually. As mentioned above, a user-interface is provided for this purpose where the notifications generated at step 64 are available to display and review.

In some cases it will not be possible, even in principle, for errors to be corrected. This will usually be the case where the existing messaging security system has refused a connection from a peer MTA or has refused or dropped a message. Based on the received notification the messaging recovery engine is still able to determine whether the message is wanted or not without a copy ever having been stored. In this situation, the messaging recovery engine will simply include in the generated notification what it knows (that a message from a known good sender was refused/dropped, or that a connection from an IP address known to send some legitimate email was refused) and even though no release is possible.

The means of releasing messages varies enormously between messaging security systems. For the sake of illustration, the means of releasing messages from Postini® is described:

The “User ID” field in the Postini CSV log file contains a number of the form 99-99999999. The preceeding 99- is removed and the remaining 8 digits recorded for later use.

An HTTP POST is sent to /exec/admin_users with the following parameters:

| | |
|---|---|
| pagesize | 25 |
| msgtype | visible |
| firstmsg | 1 |
| msgsort | date |
| filterRecip | (empty string) |
| filterSender | (empty string) |
| filterSubject | (subject, up to and excluding first double- |
| | quote) |
| filterBlock | (empty string) |
| deliv_rcpt | user |
| action | processQuarantine |
| targetuserid | (the truncated User ID recorded above) |

The result is parsed for the first attribute with a value which starts with the “Message ID” value from the Postini log CSV; the entire value is recorded for later use.

| | |
|---|---|
| pagesize | 25 |
| msgtype | visible |
| firstmsg | 1 |
| msgsort | date |
| filterRecip | (empty string) |
| filterSender | (empty string) |
| filterSubject | (empty string) |
| filterBlock | (empty string) |
| msgid | (the extended message ID recorded above) |
| submit | Process |
| deliv_rcpt | user |
| markdeliver | 1 |
| preclean | 1 |
| action | processQuarantine |
| targetuserid | (the truncated User ID recorded above) |

The result is parsed for the string “message(s) queued for delivery” to determine whether, in fact, the message was released.

On a configured schedule, the report generation module creates summary reports of the generated notifications, that is messages that were detected as false-positive errors and then corrected. In simpler cases, this report consists simply of a CSV file listing for each message: source IP address, sender and recipient's email addresses and subject header. For messaging security systems with very large numbers of errors, only summary statistics are reported. For each messaging security system that messaging recovery engine installation is monitoring, different reporting intervals, report retention periods and notification settings (whether reports are simply generated and stored, or also emailed to specified addresses) may be specified.

A user interface for browsing the detected false positives and manually releasing them is also provided for users who would prefer not to have correction not performed automatically.

Further detail of step 62 of FIG. 3 will now be described.

For better accuracy logs of both inbound and outbound messages are available to the messaging recovery engine. If the relevant logs are not available it is still possible to have the inbound-classified-as-spam and outbound message streams copied to the messaging recovery engine via SMTP as described earlier, in which case the appropriate identification information for each email can be extracted and determination 62 can proceed as usual.

Much of the integrity engine's—and therefore the messaging recovery engine's-operation depends upon observing email communication in both directions. Situations in which a security service provider secures a customer's inbound email stream but has no contact with the corresponding outbound stream arise frequently. In such cases, the integrity engine's ability to use a global reputation system, such as TrustCloud, provides the messaging recovery engine with the ability to perform a large subset of the error correction that could otherwise be performed.

In some situations, the messaging recovery engine's most important function is raising the visibility of the problem, in which case quarantine access is not a requirement; the ability to report what messages are being lost is sufficient. In some situations the messaging recovery engine's function is to provide information to support SLA compliance monitoring in which case, again, quarantine access is not a requirement.

In situations where recovery is desired it is sometimes the case that the messaging security system is use provides no means to release messages from quarantine, or customers with bespoke systems may elect not to support integration of their quarantine with the messaging recovery engine. In these situations a copy of the inbound-classified-as-spam message stream being delivered to the messaging recovery engine via SMTP to function as an internal “quarantine” from which misclassified-as-spam messages can be released.

Step 62 may comprise dynamically selecting the best method of determining whether the email is wanted. The selection may be made per email or based on the messaging security system which originally identified the message as unwanted. For example, where more information about the email is known, the most accurate and robust method of performing step 62. Where limited information is known step 62 may be simply a global white list look up.

The messaging recovery engine can be scaled. As the messaging recovery engine operates slightly after the fact, its performance is rarely critical, however for large installations the workload will readily exceed what can be performed by a single server. Fortunately the messaging recovery engine retains very little persistent state and what little it retains is slow-changing, rarely-aggregated, or both.

Several components (log receivers and converters, the recovery module, releasing modules) operate statelessly and can therefore be horizontally scaled as required.

A single server (or two, where high-availability is required and virtualisation is not in use) will suffice for the master copy of the configuration database and admin UI/API, even for very large installations, as the rate of change is negligible: typically only the additional and removal of messaging systems being monitored or—at worst—the addition and removal of domains on those systems need be recorded. Read-only replicas of the configuration database can trivially be distributed to other components as required.

The two “queues” can be parallelised and therefore scaled using known message queuing systems. In some cases, these queues can also be ephemeral and, for example, built into the source log receiving and converting component.

A single server (or two, where high-availability is required and virtualisation is not in use) will suffice for the reporting database and module. The reporting module does need to aggregate all data related to a particular messaging security system collected over a period of time and, therefore, needs to work with data that may have originated from any of multiple servers in a large installation, however detected false positives typically number three orders of magnitude below the total number of messages processed by a messaging security system.

It will be appreciated by persons skilled in the art that further numerous variations and/or modifications may be made to the subject matter shown in the specific embodiments without departing from the scope of the claims as broadly described.

For example, the messaging recovery engine and the integrity engine need not be local to each other.

The messaging recovery engine and the integrity engine may be distributed systems. 30 may be distributed.

The single messaging recovery module is in communication with multiple messaging systems and multiple instances of the integrity engine.

Electronic messaging/communication may be defined as a system that transmits data or provides a communications channel between two parties in an electronic format such as email, SMS or VoIP. The example makes use of the terminology used for email. However, it may be applied to any electronic messaging or communications system that connects two or more parties.

In the example above the messaging recovery engine depicted as separate from the integrity engine, in other embodiments they may be integrated.

The ports are described as communication ports. The messaging security system 10 and messaging recovery engine may have numerous communication ports, may be separated into combine I/O ports or dedicated separate input ports and output ports. For example, 38 and 45 may in fact be the same port.

The components of the processor may be a combination of both hardware and software acting on the hardware.

It should also be understood that, unless specifically stated otherwise as apparent from the following discussion, it is appreciated that throughout the description, discussions utilizing terms such as “generating”, “providing”, “receiving”, “processing”, “retrieving”, “selecting”, “calculating”, “determining”, “displaying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices. Unless the context clearly requires otherwise, words using singular or plural number also include the plural or singular number respectively.

The present embodiments are, therefore, to be considered in all respects as illustrative and not restrictive.

1. A computer-implemented method for reducing incorrect identification of wanted inbound electronic messages as unwanted electronic messages, the method comprising the steps of:
(a) receiving a notification of an inbound electronic message that has been identified as unwanted and not delivered to the addressed recipient of the electronic message, the notification including identification information of the electronic message;
(b) based on the identification information, determining whether the identification of the inbound electronic message as unwanted is substantially incorrect; and
(c) if identification of the electronic email as unwanted is determined as substantially incorrect, generating a notification that the electronic message is wanted.

2. The computer implemented method of claim 1, wherein step (a) further includes receiving notifications of a plurality of inbound electronic messages identified as wanted and outbound electronic messages, the notifications including identification information of the electronic messages, and step (b) is also based on at least the identification information of the plurality of outbound electronic messages.

3. The computer implemented method of claim 1, wherein the notification is provided by a messaging security system.

4. The computer implemented method of claim 1, wherein the notification is received by downloading from a datastore the notification from which the notifications can be determined.

5. The computer implemented method of claim 1, wherein step (b) comprises performing a method of reducing incorrect identification of wanted inbound electronic messages received from a communications network as unwanted electronic messages.

6. The computer implemented method of claim 1 wherein step (b) comprises sending a query containing the identification information to a messaging security system and receiving in reply an indication of whether the identification of the inbound electronic message as unwanted is substantially incorrect.

7. The computer implemented method of claim 1, wherein the method used for determining in step (b) is dynamically selected based on the types of identification information received for the electronic message or where the notification is received from.

8. The computer implemented method of claim claim 1, wherein the notification of step (c) causes the electronic message to be delivered to the addressed recipient.

9. The computer implemented method of claim 8, wherein generating the notification of step (c) comprises sending instructions to a messaging system to cause the electronic message to be delivered.

10. The computer implemented method of claim 1, wherein the method further comprises storing the notification that the electronic message is wanted.

11. The computer implemented method of claim 1, wherein the method further comprises repeating the method so as to generate notifications that further electronic messages identified as unwanted are wanted, and the notifications of step (a) are received from multiple sources and/or in different formats, and the method further comprises the step of processing the received notifications to be in a suitable predetermined single format for use in step (b).

12. A computer system for reducing incorrect identification of wanted inbound electronic messages as unwanted electronic messages, comprising:
an input port to receive a notification of an inbound electronic message that has not been delivered to the addressed recipient of the electronic message, the notification including identification information of the electronic message; and
a processor to determine, based on the identification information, whether the identification of the inbound electronic message as unwanted is substantially incorrect and if the electronic email identified as unwanted is determined as being substantially incorrect, generating a notification that the electronic message is wanted.

13. A non-transitory computer readable medium storing a program comprising instructions, wherein when the program is installed and executed by a computer system, the program causes the computer to perform the method according to claim 1.

14. A computer-implemented method for reducing incorrect identification of wanted inbound electronic messages as unwanted electronic messages, the method comprising:
(a) determining that an inbound electronic message is unwanted to prevent the electronic message from being delivered to the addressed recipient of the electronic message;
(b) providing or making available a notification that the inbound electronic message has been identified as unwanted to a third party electronic messaging security system, the notification including identification information of the electronic message; and
(c) receiving instructions from the third party electronic messaging security system to cause the electronic message to be delivered to the addressed recipient.

15. A computer system for reducing incorrect identification of wanted inbound electronic messages as unwanted electronic messages, comprising:
a processor to determine that an inbound electronic message is unwanted preventing the electronic message from being delivered to the addressed recipient of the electronic message, and to cause the electronic message to be delivered to the addressed recipient on instruction from a third party electronic messaging security system; and
a communications port to provide or make available a notification that the inbound electronic message has been identified as unwanted to the third party email security system and to receive instructions from the third party email security system to cause the electronic message to be delivered to the addressed recipient.

16. A non-transitory computer readable medium storing a program comprising instructions, wherein when the program is installed and executed by a computer system, the program causes the computer to perform the method according to claim 14.
